(19) United States
(12) Patent Application Publication
(10) Pub. No.: US 2006/0141636 A1
(43) Pub. Date: Jun. 29, 2006

(54) Apparatus and method to elute microorganisms from a filter

(76) Inventors: Darron Steggles, Cambridgeshire (GB); Brett Brewin, Cambridgeshire (GB)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/303,531

(22) Filed: Dec. 16, 2005

Related U.S. Application Data
(60) Provisional application No. 60/636,678, filed on Dec. 16, 2004.

(51) Int. Cl. G01N 1/18

(52) U.S. Cl. 436/177

(57) ABSTRACT

There is provided apparatuses and methods for eluting microorganisms from filter media. The apparatus includes a housing for receiving filer media suspected of containing microorganisms and means for exposing the filter media to a pressurized buffer solution. By passing the buffer solution through the filter media under pressure, microorganisms trapped in or on the filter media are eluted therefrom.

### CROSS-REFERENCE TO RELATED APPLICATIONS

The present application claims the benefit of and priority to U.S. Provisional Application Ser. No. 60/636,678, filed on Dec. 16, 2004, the entire contents of which being incorporated herein by reference.

### BACKGROUND

1. Technical Field

The present disclosure relates to apparatuses and methods for eluting or otherwise removing microorganisms from filter media.

2. Discussion of Related Art

The determination and enumeration of microbial concentration is an essential part of microbiological analyses in many industries, including water, food, cosmetics, and pharmaceuticals. Microorganisms, of interest to water microbiology, such as Cryptosporidium spp. and Giardia spp, are often present in low concentrations. This generates a requirement to sample large volumes of water to generate meaningful data. In the water industry, typically, 1,000 liters of finished water or 10-50 liters of surface water (e.g. lake water, river water etc.) are filtered to test for the presence of Cryptosporidium spp. oocysts and Giardia spp. cysts. Following filtration, these organisms must be recovered for further identification and quantification. Two major commercial filtration devices and methods are approved in the United States and United Kingdom for this application.

U.S. Pat. No. 5,690,825 disclose the use of an expansible, compressed, open cell, solid foam to capture and recover microorganisms such as Cryptosporidium spp. and Giardia spp. by filtering large volumes of liquid samples (e.g. water) through the filter. The contents of the '825 patent are herein incorporated by reference. Captured organisms are released from the foam filter by removing the compression and washing the target organisms from the foam matrix. A compressed foam filter device and automated washing/eluting device is currently marketed by IDEXX Laboratories, Inc., Westbrook, Me. under the Filta-Max® trademark. The Filta-Max elution procedure and wash station includes steps to decompress the foam filter modules first followed by repeated strokes of compressing and decompressing the Filta-Max filter in the presence of a buffer solution using a reciprocating plunger. The buffer solution used in the Filta-Max method includes an aqueous solution of PBST (phosphate buffer saline—0.01% Tween 20). The current process of eluting microorganisms from the Filta-Max® device and methods requires a washing procedure that is significantly more labor intensive than the presently disclosed invention.

Pall Gelman Sciences Inc. manufactures and sells membrane filters (available from Pall Corporation) for capture and recovery of microorganisms from large volume water samples. The filter devices are currently marketed under the Envirochek™ trademark (hydrophilic polyethersulfone filter media) and the Envirochek™ HV trademark (hydrophilic polyester membrane). The process of eluting microorganisms from either of these devices and methods requires a washing procedure that is significantly more labor intensive than the presently disclosed invention.

It is therefore, an object of the present invention to provide an apparatus and method of eluting microorganisms from filter media that is faster, easier to use and more efficient than currently marketed devices and methods.

### SUMMARY

The present invention discloses a novel and efficient apparatus and method of eluting microorganisms from filter media. Generally, the apparatus includes a pressure chamber in which the filter media suspected of containing microorganisms is placed or to which the filter media is fluidly connected. A buffer solution is disposed in the pressure chamber on one side of the filter media. Following pressurization of the chamber, an outlet is opened on the other side of the filter media, allowing the pressure and buffer solution to rapidly pass, in a flow direction reversed to the sampling direction, through the filter media resulting in efficient elution of microorganisms from the filter media. The process may be repeated, depending on the desired elution efficiency and microorganism recovery rates.

According to an aspect of the present disclosure, an apparatus for eluting microorganisms from filter media is provided. The apparatus includes a housing configured and dimensioned to receive filter media, the housing having an inlet and an outlet; filter media disposed in the housing, the filter media having been exposed to a liquid suspected of containing microorganisms; means for transporting a liquid buffer solution into the housing via the outlet; and means for causing the liquid buffer solution to pass through the filter media under pressure and to exit the housing via the inlet.

The means for causing the fluid buffer solution to pass through the filter media may include a pressurizing assembly selectively connectable to the outlet of the housing. The pressurizing assembly may include a pressure chamber configured for pressurizing a quantity of a liquid buffer solution therein prior to transportation of the liquid buffer solution to the housing. The pressure chamber may be in selective fluid communication with a source of pressurizing gas. The pressurizing assembly may include an air valve fluidly disposed between the source of pressurizing gas and the pressure chamber and a non-return valve fluidly disposed between the air valve and the pressure chamber.

The apparatus may further include a reservoir configured to store a quantity of a liquid buffer solution therein, and a first conduit in fluid communication with the reservoir. The first conduit may include a free end configured to selectively fluidly connect with the pressure chamber.

The apparatus may further include a liquid buffer solution contained within the reservoir.

The apparatus may further include a buffer inlet valve fluidly disposed between the reservoir and the pressure chamber.

The apparatus may still further include an elution valve fluidly connected to the pressure chamber and fluidly connectable to the outlet of the housing.

The apparatus may further include a venting valve fluidly connected to the pressure chamber.

It is contemplated that the pressure chamber may be pressurizable to a pressure of between about 0 psi (0 Bars) to at least about 72.5 psi (5.0 Bars).

It is envisioned that the filter media may include a plurality of discs stacked upon one another. The stack of discs may alternate between relatively large outer diameter discs and relatively small outer diameter discs. The stack of discs may be compressed in a linear direction.

According to a further aspect of the present disclosure a method for eluting microorganisms from filter media is provided. The method includes the steps of providing filter media suspected of containing microorganisms; and forcing a pressurized liquid through the filter media to at least partially elute microorganisms from the filter media, if present.

It is envisioned that step of forcing a pressurized liquid through the filter media may include forcing the pressurized liquid through the filter media in a direction opposite to a direction of filtration.

The method may further include the step of forcing a fixed quantity of pressurized liquid at a known initial pressure through the filter media.

The method may still further include the step of providing an apparatus for eluting the filter media, as described above.

The method may further include the step of introducing a fixed quantity of liquid buffer solution to the pressure chamber.

The method may further include the step of pressurizing the pressure chamber a pressure of between about 0 psi (0 Bars) to at least about 72.5 psi (5.0 Bars).

The method may further include the step of forcing the pressurized liquid buffer solution through the filter media.

### BRIEF DESCRIPTION OF THE DRAWINGS

The foregoing advantages and features of the presently disclosed apparatus and methods for liquid sample testing will become more readily apparent and may be understood by referring to the following detailed descriptions of illustrative embodiments, taken in conjunction with the accompanying drawings, in which:

FIG. 1 is a schematic illustration of an apparatus for eluting microorganisms from a filter, in accordance with an embodiment of the present disclosure;

FIG. 2 is a schematic illustration of a pressurizing assembly of the eluting apparatus of FIG. 1;

FIG. 3 is a schematic illustration of a pressurizing assembly according to an alternate embodiment of the present disclosure;

FIG. 4 is a schematic side elevational view of an exemplary prior art filter module or device which may be eluted with the eluting apparatus of the present disclosure;

FIG. 5A is a side elevation view of a filter element, according to an embodiment of the present disclosure, for use in filter device;

FIG. 5B is a top plan view of a first disc member of the filter element of FIG. 5A;

FIG. 5C is a top plan view of a second disc of the filter element of FIG. 5A; and

FIG. 6 is a graph illustrating the recovery efficiencies of Cryptosporidium parvum oocysts and Giardia lamblia cysts using different pressure elution procedures.

### DETAILED DESCRIPTION OF PREFERRED EMBODIMENTS

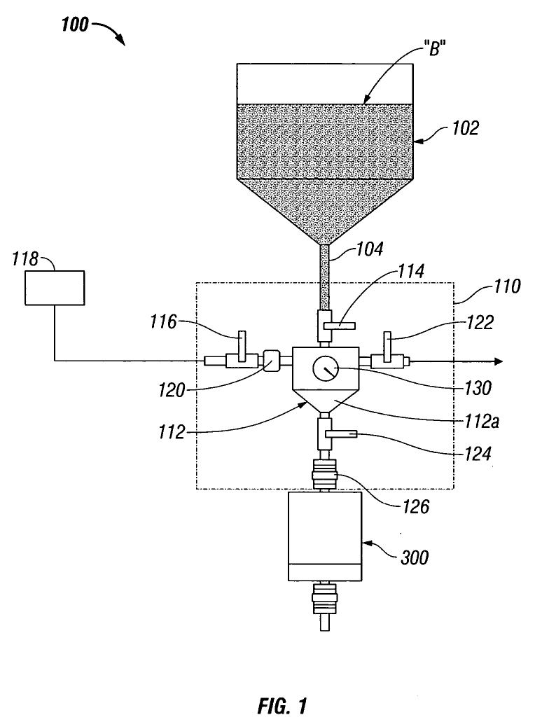

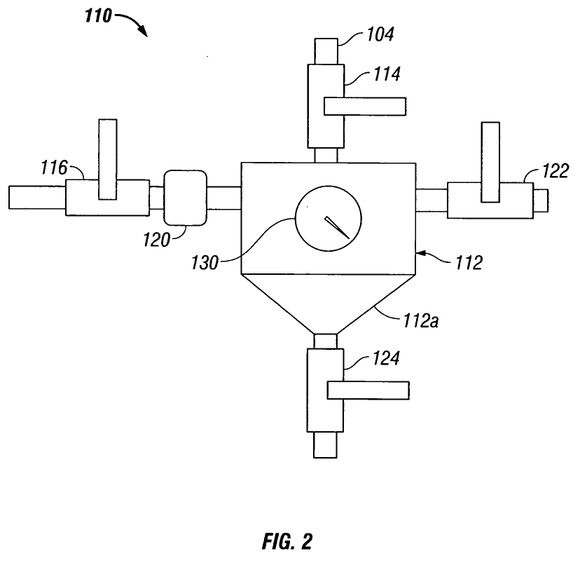

The present disclosure will now be described more fully hereinafter with reference to the accompanying drawings, in which preferred embodiments of the disclosure are shown. Referring initially to FIGS. 1 and 2, an embodiment of an apparatus to elute microorganisms from a filter, filter module, filter device or the like, in accordance with the present disclosure, is generally designated as 100. Although the presently disclosed elution apparatus 100 will be described and illustrated hereinafter in connection with specific embodiments and uses, such as, for example, the elution of Cryptosporidium and/or Giardia for filter modules/devices, it will be readily appreciated and understood by one skilled in the art that the presently disclosed elution apparatus 100 may be used in other applications equally as well or the elution apparatus 100 and methods disclosed herein may be adapted for use with a wide range of other filter modules/devices.

With reference to FIGS. 1 and 2, elution apparatus 100 includes a reservoir or chamber 102. Reservoir 102 is adapted to contain a quantity of a buffer solution “B” therein. As used herein, the buffer solution is any solution used to effect elution of the filter contained in the filter module housing. For example, the buffer solution may be a phosphate-buffered saline with 0.01% Tween 20. Alternatively, the buffer may comprise 0.1% Laureth 12, 10 mM Tris buffer, 1 mM di-sodium EDTA, and 0.015% antifoam A. It is further envisioned that the surfactant ingredients in the buffer solution may be selected from Tween 80, Igepal CA720, Niaproof, Laryl Sulphate, and Igepal CA630. A preferred buffer solution includes, for example, an aqueous solution of 0.02% (w/v) (or 0.45 mM) sodium pyrophosphate tetrabasic decahydrate, 0.03% (w/v) (or 0.84 mM) ethylenediaminetetraacetic acid trisodium salt and 0.01% (v/v) polyoxyethylenesorbitan monooleate (Tween 80), the complete disclosure of which is found in Inoue, M., Rai, S. K., Oda, T., Kimura, K., Nakanishi, M., Hotta, H., Uga, S., 2003, “A New Filter-eluting Solution that Facilitates Improved Recovery of Cryptosporidium Oocysts from Water,” J. Microbiol. Methods. 55, 679-686, the entire disclosure of which is incorporated herein by reference. An even further preferred buffer solution includes an aqueous solution of 0.01 M Tris-HCL containing 0.02% (w/v) (or 0.45 mM) sodium pyrophosphate tetrabasic decahydrate, 0.03% (w/v) (or 0.84 mM) ethylenediaminetetraacetic acid trisodium salt and 0.01% (v/v) polyoxyethylenesorbitan monooleate (Tween 80). The reservoir 102 is envisioned to have at least 250 mL capacity; preferably, the reservoir will have a 10 L capacity for retaining buffer solution

As seen in FIGS. 1 and 2, elution apparatus 100 further includes a pressurizing assembly 110 fluidly connected to reservoir 102 via a first conduit 104. Pressurizing assembly 110 includes a pressure chamber 112 fluidly connected to reservoir 102. In one preferred embodiment, the pressure chamber 112 has a 2.0 liter capacity and is capable of withstanding a pressure of at least 1 bar and preferably up to 12 bars. It is preferred that pressure chamber 112 includes a conical or frusto-conical lower portion 112a in order to facilitate the ejection of fluid therefrom.

Pressurizing assembly 110 includes a first inlet or buffer inlet valve 114 fluidly connected between reservoir 102 and pressure chamber 112. Buffer inlet valve 114 controls the inflow of buffer solution “B” into pressure chamber 112. Pressurizing assembly 110 also includes a second inlet or compressed air inlet valve 116 fluidly connected between pressure chamber 112 and an air compressor, pump or the like 118. Air inlet valve 116 controls the inflow of compressed air and/or other pressurizing gases into pressure chamber 112. Preferably, a non-return valve 120 or the like may be fluidly connected between air inlet valve 116 and pressure chamber 112. Non-return valve 120 prevents pressure loss from pressure chamber 112 back through air inlet valve 116.

Pressurizing assembly 110 may optionally include a third or venting valve 122 fluidly connected to pressure chamber 112. The venting valve 122 allows air to exit pressure chamber 112 when pressure chamber 112 is being filled or charged with buffer solution “B”.

Pressure assembly 110 further includes a fourth or elution valve 124 fluidly connected to pressure chamber 112. Desirably, elution valve 124 is fluidly connected to lower portion 112a of pressure chamber 112. Preferably, a fitting 126 is connected to a free end of elution valve 124. The fitting 126 is configured and adapted to fluidly connect a filter housing or device 300 to elution valve 124.

Pressurizing assembly 110 further optionally includes a pressure gauge 130 operatively connected to pressure chamber 112 for measuring and displaying the pressure within pressure chamber 112.

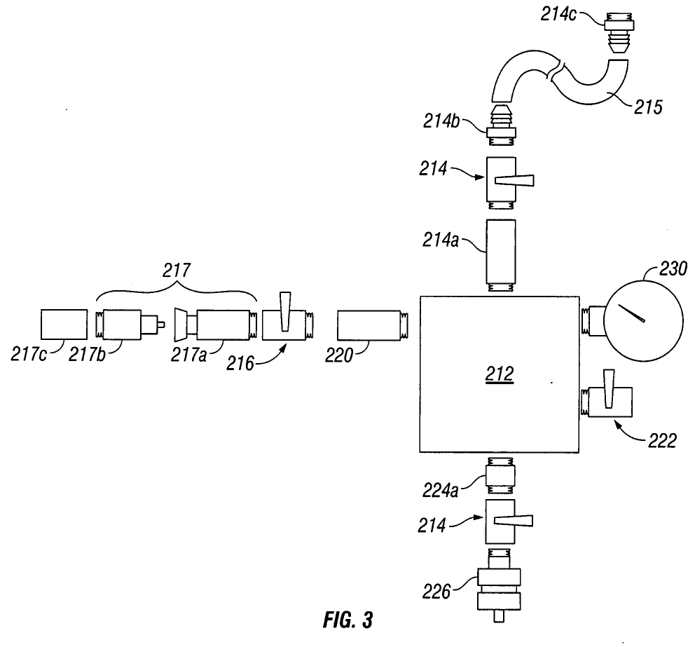

Turning now to FIG. 3, an alternate embodiment of pressurizing assembly 110 is shown generally as 210. Pressurizing assembly 210 is similar to pressurizing assembly 110 and will only be discussed in detail to the extent necessary to identify differences in construction and operation.

As seen in FIG. 3, pressurizing assembly 210 includes a first inlet or buffer inlet valve 214 fluidly connected to pressure chamber 212 by a first union member 214a. A first nipple 214b is operatively connected to buffer inlet valve 214 for connection with a first end of a tube or the like 215. A second end of tube 215 may include a second nipple 214c for connection to reservoir 102 (see FIG. 1).

Pressurizing assembly 210 also includes a second inlet valve or compressed air inlet valve 216 fluidly connected between pressure chamber 212 and an air compressor, pump or the like 118 (see FIG. 2). Preferably, a non-return valve 220 is fluidly connected between the compressed air inlet valve 216 and pressure chamber 212. Non-return valve 220 prevents pressure loss from pressure chamber 212 back through the compressed air inlet valve 216. Preferably, a first member 217a of a two-part quick-connect coupling 217 is connected to the compressed air inlet valve 216. A second member 217b of the two-part quick-connect coupling 217 may be connected to a hose (not shown) extending from compressor 118 (see FIG. 1) via a fitting 217c.

Pressurizing assembly 210 further includes a third or venting valve 222 fluidly connected to pressure chamber 212. The venting valve 222 allows air to exit pressure chamber 212 when pressure chamber 212 is being filled or charged with buffer solution “B”.

Pressure assembly 210 further includes a fourth or elution valve 224 fluidly connected to pressure chamber 212 by a first union member 224a. Preferably, a fitting 226 is connected to a free end of elution valve 224 for fluidly connecting a filter housing or device 300 to elution valve 224.

Pressurizing assembly 210 further optionally includes a pressure gauge 230 operatively connected to pressure chamber 212 for measuring and displaying the pressure within pressure chamber 112.

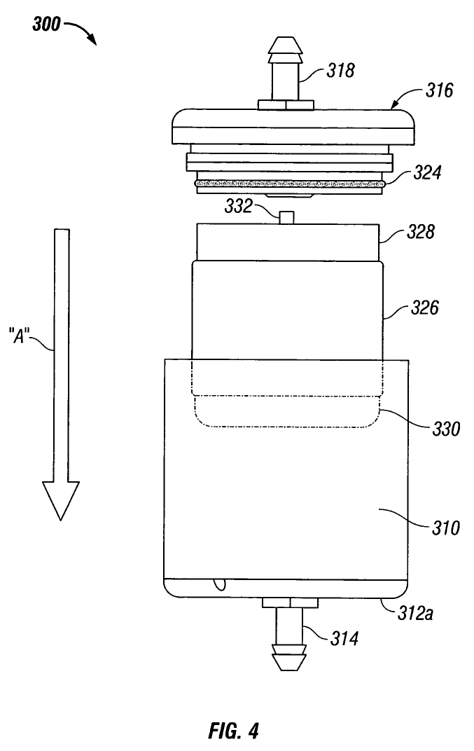

Turning now to FIG. 4, an exemplary filter device or module, for use to capture and recover target microbes such as Cryptosporidium spp. and Giardia spp. from the samples and for use with the elution apparatus 100, is shown generally as 300.

By way of example only, filter device 300 includes a filter housing 310 having a generally cylindrical body provided with a fixed outlet end 312a having an axially extending outlet tube 314. A cap 316 is provided at an inlet end 312b and includes an axially extending inlet tube 318. Cap 316 is secured to inlet end 312b of cylindrical body 310 by a threaded connection and sealed by an O-ring 324. The direction of flow, during the filtration process, though filter device 300 is indicated by arrow “A”. Within housing 310 is a filter element 326. Filter device 300 includes an upstream compression member, in the form of an apertured end plate 328, and a downstream compression member, in the form of an apertured end plate 330, connected by a rod member, in the form of a bolt 332, passing through a central aperture of each end plate 328, 330. Between end plates 328, 330 are compressed approximately 60 circular discs 326 of reticulate foam each having an uncompressed thickness of approximately 1 cm and an uncompressed porosity of 90 ppi (36 pores per cm). Circular discs 326 have been stacked end-over-end plane 328 and bolt 332 and have been pushed down by end plate 330 to compress the foam layers to an overall thickness of from 2 to 3 cm. Reference may be made to U.S. Pat. No. 5,690,825, the entire contents of which are incorporated herein by reference, for a detailed discussion of filter device 300. Exemplary filter devices 300 are marketed and available from IDEXX Laboratories, Inc., Westbrook, Me., under the Filta-Max® trademark.

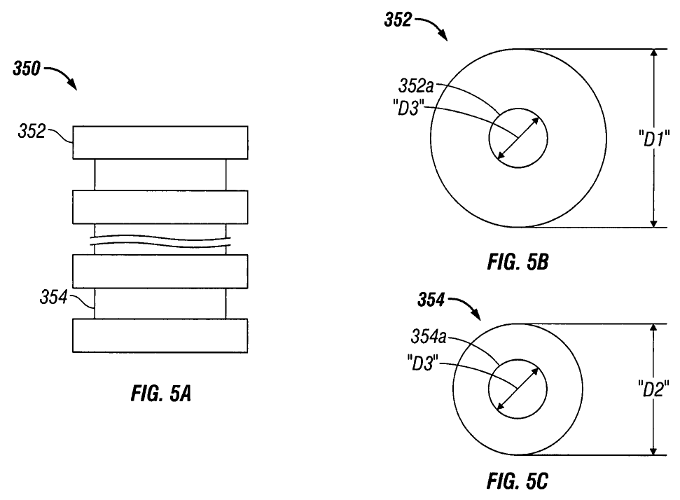

Turning now to FIGS. 5A-5C, in accordance with the present disclosure, a filter element for use in filter device 300, is shown generally as 350. Filter element 350 is multi-tiered and includes a plurality of first filter members 352 and second filter members 354 stacked in alternating arrangement with one another. Preferably, filter element 350 includes forty (40) first filter members 352 and thirty-nine (39) second filter members 354. While a filter element 350 having forty first filter members 352 and thirty-nine second filter members 354, arranged in alternating relationship, has been described, it is envisioned and within the scope of the present disclosure that any number of first and second filter members 352, 354 may be used and may be arranged in any order.

As seen in FIG. 5B, desirably, first filter members 352 is circular having an outer diameter “D1” and defining a central opening 352a having an inner diameter “D3”. Preferably, outer diameter “D1” of first filter member 352 is approximately 55 mm (˜2.17 inches) and inner diameter “D3” of first filter member 352 is approximately 18 mm (˜0.71 inches).

As seen in FIG. 5C, preferably, second filter members 354 is circular having an outer diameter “D2” and defining a central opening 354a having an inner diameter “D3”. Preferably, outer diameter “D2” of second filter member 354 is approximately 40 mm (˜1.57 inches) and inner diameter “D3” of second filter member 354 is equal to the inner diameter of central opening 352a of first filter member 352.

Preferably, first and second filter members 352, 354 are fabricated from expansible, open cell reticulated foam or the like. The foam is compressed so as to reduce its effective pore size to a level sufficient to filter large volumes of liquid samples and capture small particles or microbes such as Cryptosporidium spp. and/or Giardia spp. in the sample.

Preferably, filter element 350 may be placed in filter device 300 in lieu of circular discs 326 described above. Use of filter element 350 helps to maintain a flow rate through filter device 300 within acceptable limits as well as reducing the incidence of target organisms bypassing the filter element. More preferably,

With reference to FIGS. 1-4, in accordance with the present disclosure, a method of using elution apparatus 100 to elute a filter device 300, is shown and described. In accordance with the method, buffer solution “B” is transmitted to or introduced into pressure chamber 112. In particular, with venting valve 122 open in order to vent air or gases from within pressure chamber 112 and air inlet valve 116 and elution valve 124 in a closed condition, buffer inlet valve 114 is manipulated to an open condition to open the passage between reservoir 102 of buffer solution “B” and pressure chamber 112. Preferably, reservoir 102 is located above pressure chamber 112 so that buffer solution “B” is transmitted via a gravity feed, however, any method of introducing buffer solution “B” into pressure chamber 112 is contemplated, for example, by pouring into a sealable opening, using positive pressure to deliver buffer solution “B” to pressure chamber 112, etc. Preferably, an effective amount or quantity of buffer solution “B” is introduced into pressure chamber 112. For example, approximately 240 ml of buffer solution “B” is transferred from the reservoir 102 into the pressure chamber 112 for each elution process.

With buffer solution “B” introduced into pressure chamber 112, buffer inlet valve 114 is once again manipulated in order to close the passage between reservoir 102 of buffer solution “B” and pressure chamber 112. Additionally, venting valve 122 is also manipulated to a closed position in order to prevent the escape of gas or buffer solution “B” from pressure chamber 112.

Once buffer solution “B” is contained in pressure chamber 112 and venting valve 122 is closed, air inlet valve 116 is manipulated to the open condition. By opening air inlet valve 116, pressure chamber 112 is pressurized with air or the like from air compressor 118. Air inlet valve 116 is maintained open until the pressure within pressure chamber 112 is about 1.0 bar (approximately 14.5 psi) to about 5.0 bars (approximately 72.5 psi), preferably about 4.0 bars (approximately 58 psi) at which time air inlet valve 116 is closed. The pressure within pressure chamber 112 is measured and visualized by pressure gauge 130.

At this point in the process, or, if desired, prior to this point, a filter device 300 is fluidly connected to elution valve 124. In particular, the outlet tube 314 of filter device 300 is connected to elution valve 124. Filter device 300 is preferably a filter device which has become at least partially saturated with microorganisms (e.g., Cryptosporidium and Giardia) after performing numerous hours of filtering and/or after having filtered numerous gallons of fluid. In order to capture and/or contain the expurgated fluid or eluate (i.e., buffer solution “B” and the microorganisms from filter device 300) a collection container or the like is placed beneath inlet tube 318 of filter device 300, or alternately, a fluid conduit (not shown) may be fluidly connected to inlet tube 318 of filter device 300.

With the pressure within pressure chamber 130 at or about the desired or required pressure, elution valve 124 is manipulated to the open condition thereby forcing pressurized buffer solution “B” through filter device 300, in a direction opposite to arrow “A” of FIG. 4. In so doing, microorganisms captured and/or contained in filter device 300 are driven out of and/or forced out of filter element 326 of filter device 300.

Once the eluate is collected, elution valve 124 is manipulated to the closed condition. Filter device 300 may then be removed from elution valve 124 and discarded or reconditioned for further filtering operations. If required and/or desired, venting valve 122 may be re-opened to further vent pressure chamber 112. The eluate may then be further processed and/or analyzed as known by those having ordinary skill in the art. It is envisioned and within the scope of the present disclosure that the filter device 300 may be maintained attached to or re-attached to elution valve 124 and additional pressurized buffer solution “B” forced therethrough in order to further expurgate and/or elute additional microorganisms.

This invention and its benefit can be further illustrated by the following examples:

### Example 1

### Recovery Efficiencies of Cryptosporidium spp. oocysts and Giardia spp. cysts from Drinking Water Samples

Initially, 1,000 liters and 50 liters of drinking water samples from Newmarket, UK and Veolia Water Company, UK were spiked with 100 Cryptosporidium parvum oocysts and 100 Giardia lamblia cysts (Waterborne™, Inc. New Orleans, La., USA). The packed pellet sizes were <0.5 mL for the Newmarket sample and 0.5 mL for the Veolia sample. Water samples containing the spiked Cryptosporidium spp. oocysts and Giardia spp. cysts were passed through each of the filter modules of the Filta-Max, and a 79-Disc filter according to the structure briefly described above in FIG. 5. The 79-Disc filter module consists of 79 open cell reticulated foam pad rings with two different sizes: 40 of the large foam pads have a 55 mm outer diameter and an 18 mm inner diameter and 39 of the small foam pads have a 40 mm outer diameter and an 18 mm inner diameter. All the foam rings of the 79-Disc filter are 10 mm thick. The two sizes of foam pads (i.e., the 55 mm and the 40 mm pads) are sandwiched in an alternating pattern into a stack. The stack is then compressed from about 790 mm to about 30 mm and is tightened by a retaining bolt. This construction resulted in a filter module with two filtration layers: the outer layer of the filter module (i.e., the region radially outward of the outer diameter of the 40 mm foam pads) is compressed 13 fold and acts as a pre-filter and the inner layer of the filter module (i.e., the region radially inward of the outer diameter of the 40 mm foam pads) is compressed 27 fold and acts as a size exclusion filter.

The Filta-Max method is the standard method in England and is approved by the Drinking Water Inspectorate (DWI). DWI is responsible for assessing the quality of drinking water in England and Wales, taking enforcement action if standards are not being met and appropriate action when water is unfit for human consumption. The filtered Filta-Max modules were processed and the captured organisms were eluted using the standard Filta-Max elution procedure as described in the DWI procedure. In this experiment, both minimally expanded (5 mm) and non-expanded 79-Disc filter were tested using one embodiment of this invention. The filters were eluted in a flow direction reversed to the sampling step only once with 240 mL pressurized buffer solution (0.45 mM sodium pyrophosphate, 0.84 mM tri-sodium EDTA, 0.01% Tween 80) at 5 bars pressure (i.e. 72.5 psi). The organisms in the eluted filtrates were purified using a standard immunomagnetic separation method (Dynal® Invitrogen Corporation, Carlsbad, Calif., USA), stained with a fluorescent antibody stain, and enumerated using a fluorescent microscope. As shown in the table below, these data indicated that, using the device and method of this invention, the recovery efficiencies were equivalent or better than the official method, Filta-Max.

| | | Cryptosporidium | | Giardia | |
|---|---|---|---|---|---|
| Filter & Elution Methods | Sample Sources | Recovery | Mean | Recovery | Mean |
| Filta-Max/DWI | Newmarket, UK | 35.4% | 37.5% | 17.2% | 21.5% |
| | Veolia Water, UK | 39.5% | | 25.8% | |
| 79 Disc filter (0 mm)/PE | Newmarket, UK | 24.6% | 33.6% | 24.2% | 23.3% |
| | Veolia Water, UK | 42.6% | | 22.4% | |
| 79 Disc filter (5 mm)/PE | Newmarket, UK | 33.6% | 43.7% | 20.5% | 27.5% |
| | Veolia Water, UK | 53.7% | | 34.4% | |

### Example 2

### Recovery Efficiencies of Cryptospodium spp. oocysts and Giardia spp. cysts from Raw Water Samples

Initially, 50 liters of surface water samples from Iowa, North Dakota, California, and Pennsylvania were spiked with 100 Cryptosporidium parvum oocysts and 100 Giardia lamblia cysts (Waterborne™, Inc. New Orleans, La., USA). The packed pellet size for all these water samples was 0.5 mL. Water samples containing the spiked Cryptosporidium oocysts and Giardia cysts were collected using the filter modules of Gelman HV, Filta-Max, ID filter and 79-Disc filter. The 79-Disc filter module consists of 79 open cell reticulated foam pad rings with two different sizes: 40 of the large foam pads have a 55 mm outer diameter and an 18 mm inner diameter and 39 of the small foam pads have a 40 mm outer diameter and an 18 mm inner diameter. All the foam rings are 10 mm thick. The two sizes of foam pads (i.e., the 55 mm and the 40 mm pads) are sandwiched in an alternating pattern into a stack. The stack of foam pads is then compressed from about 790 mm to about 30 mm and is tightened by a retaining bolt. This construction resulted in a filter module with two filtration layers: the outer layer of the filter module (i.e., the region radially outward of the outer diameter of the 40 mm foam pads) is compressed 13 fold and acts as a pre-filter and the inner layer of the filter module (i.e., the region radially inward of the outer diameter of the 40 mm foam pads) is compressed 27 fold and acts as a size exclusion filter. The ID-filter (increased-depth) module is constructed from 67 rings of open cell reticulated polyester foam. 51 of the rings are 84 mm in diameter and 16 of the rings are 55 mm in diameter. All of the rings are 10 mm thick and have an 18 mm central hole. The rings are layered in an alternating pattern with the larger rings grouped in stacks of three interspaced by a smaller ring. The stack is compressed from about 670 mm to about 30 mm. This construction results in a filter module with two filtration layers. The outer later of the filter module (i.e., the region radially outward of the outer diameter of the 40 mm foam pads) is compressed 17 fold and acts as a pre-filter. The central core of the filter module (i.e., the region radially inward of the outer diameter of the 40 mm foam pads) is compressed 22 fold and acts as an efficient size exclusion filter.

Filta-Max and Gelman HV methods are the standard method accepted by the United Stated Environmental Protection Agency (USEPA) and are included as the USEPA Method 1623 for concentrating and recovering the Cryptosporidum spp. oocysts and Giardia spp. cysts in surface water samples. The Filta-Max module and Gelman HV were processed and the captured organisms in these filters were eluted using the standard Filta-Max and Gelman HV procedures as described in the USEPA Method 1623. Both ID-filters and 79-Disc filters were processed to elute the captured organisms using one embodiment of this invention, respectively. In this experiment, both minimally expanded (5 mm) and non-expanded filter modules of the ID-filters and 79-Disc filters were evaluated. The filters were eluted in a flow direction reversed to the sampling step only once with 240 mL pressurized buffer solution at 5 bars pressure (i.e. 72.5 psi). The organisms in the eluted filtrates were purified using a standard immuno-magnetic separation method (Dynal® Invitrogen Corporation, Carlsbad, Calif., USA), stained with a fluorescent antibody stain, and enumerated using a fluorescent microscope. As shown in the table below, these data indicated that, using the device and method of this invention, the recovery efficiencies were equivalent or better than those of the official methods, Filta-Max and Gelman HV.

| | | Cryptosporidium | | Giardia | |
|---|---|---|---|---|---|
| Filter/Elution Methods | Sample Sources | Recovery | Mean | Recovery | Mean |
| Gelman HV Filter | Iowa | 33.4 | 37.0% | 46.2 | 49.4% |
| | North Dakota | 31.1 | | 43.7 | |
| | California | 55.4 | | 52.2 | |
| | Pennsylvania | 27.9 | | 55.6 | |
| Filta-Max | Iowa | 43.5 | 37.1% | 43.1 | 37.8% |
| | North Dakota | 30.5 | | 39.4 | |
| | California | 35.7 | | 39.6 | |
| | Pennsylvania | 38.5 | | 29.2 | |
| ID Filter (0 mm) | Iowa | 29.2 | 33.8% | 38.5 | 43.7% |
| | North Dakota | 23.0 | | 23.2 | |
| | California | 36.2 | | 51.1 | |
| | Pennsylvania | 42.6 | | 62.1 | |
| ID Filter (5mm) | Iowa | 23.8 | 37.9% | 39.2 | 42.9% |
| | North Dakota | 46.6 | | 39.4 | |
| | California | 38.6 | | 37.3 | |
| | Pennsylvania | 42.6 | | 55.6 | |
| 79 Disc (0 mm) | Iowa | 44.7 | 52.0% | 47.7 | 48.2% |
| | North Dakota | 69.7 | | 57.0 | |
| | California | 52.1 | | 44.2 | |
| | Pennsylvania | 41.6 | | 43.9 | |
| 79 Disc (5 mm) | Iowa | 45.3 | 57.0% | 45.4 | 51.5% |
| | North Dakota | 72.8 | | 61.3 | |
| | California | 65.6 | | 51.7 | |
| | Pennsylvania | 44.2 | | 47.5 | |

### Example 3

### Recovery Efficiencies of Cryptosporidium spp. oocysts and Giardia spp. cysts from 50 L Surface Water Samples between Two Methods

Initially, seven (7) surface water samples including California River #1, US; Massachusetts Lake, US; Alabama River, US; an unknown River, US; Georgia Reservoir, US and River Cambridge, UK were used. With the exception of River Cambridge sample, which had a packed pellet size of 0.4 mL, the pellet sizes for all other samples were 0.5 mL. 50 liters of the indicated water samples were spiked with 100 Cryptosporidium oocyst and 100 Giardia cysts (Easyseed™, BTF Pty Ltd., North Ryde Australia). Water samples containing the spiked Cryptosporidium oocysts and Giardia cysts passed through the filter modules of Filta-Max and a 79-Disc filter with the structure described in FIG. 5. The 79-Disc filter module consists of 79 open cell reticulated foam pad rings with two different sizes: 40 of the large foam pads have a 55 mm outer diameter and an 18 mm inner diameter and 39 of the small foam pads have a 40 mm outer diameter and an 18 mm inner diameter. All the foam rings are 10 mm thick. The two sizes of foam pads are sandwiched in an alternating pattern into a stack. The stack is then compressed from about 790 mm to about 30 mm and is tightened by a retaining bolt. This construction resulted in a filter module with two filtration layers: the outer layer of the filter module (i.e., the region radially outward of the outer diameter of the 40 mm foam pads) is compressed 13 fold and acts as a pre-filter and the inner layer of the filter module (i.e., the region radially inward of the outer diameter of the 40 mm foam pads) is compressed 27 fold and acts as a size exclusion filter.

The filtered Filta-Max modules were processed and the captured organisms were eluted according to the standard Filta-Max elution procedure as described in the USEPA Method 1623 for the concentration and recovery of Cryptosporidium and Giardia in surface water samples. The 79-Disc filters were processed to elute the captured organisms using one embodiment of this invention. This elution embodiment used a 4-step elution sequence: (1) air purge with 4 bars (i.e. 58 psi) of compressed air, (2) 240 mL pressurized buffer elution at 4 bars pressure, (3) air purge with 4 bars (i.e. 58 psi) of compressed air, and (4) 150 mL pressurized buffer elution at 4 bars pressure. The buffer solution used for this elution procedure contained Sodium pyrophosphate tetra-basic decahydrate (0.2 gram/Liter), EDTA tri-sodium salt (0.3 gram/Liter), Tris-HCI (0.01M), and Tween-80 (0.1 mL/Liter). The organisms in the eluted filtrates were purified using a standard immuno-magnetic separation method (Dynal® Invitrogen Corporation, Carlsbad, Calif., USA), stained with a fluorescent antibody stain, and enumerated using a fluorescent microscope. As seen in the table below, these data indicated that, using the device and method of this invention, the mean recovery efficiencies for Cryptosporidium was 31.5% and for Giardia was 41.5%, which were about 115% for Cryptosporidium and about 128% for Giardia relative to those of the official methods, Filta-Max.

| | | Cryptosporidium | | Giardia | |
|---|---|---|---|---|---|
| Surface Water Samples | pack pellet size | Filta-Max | 79-Disc | Filta-Max | 79-Disc |
| California River #1, US | 0.5 mL | 31.6% | 37.9% | 42.6% | 44.4% |
| Massachusetts Lake, US | 0.5 mL | 40.0% | 27.1% | 28.5% | 60.0% |
| California River #2, US | 0.5 mL | 41.2% | 69.4% | 39.2% | 66.9% |
| Alabama River, US | 0.5 mL | 22.4% | 20.6% | 27.7% | 25.4% |
| Unknown River, US | 0.5 mL | 11.2% | 8.8% | 5.4% | 7.7% |
| Georgia Reservoir, US | 0.5 mL | 16.5% | 22.4% | 37.7% | 30.0% |
| Cambridge River, UK | 0.4 mL | 28.8% | 34.4% | 46.2% | 56.2% |

| | | | | |
|---|---|---|---|---|
| Overall Mean Recovery | 27.4% | 31.5% | 32.5% | 41.5% |

### Example 4

### Recovery Efficiencies of Cryptosporidium spp. oocysts and Giardia spp. cysts Using Different Pressure Elution Procedures

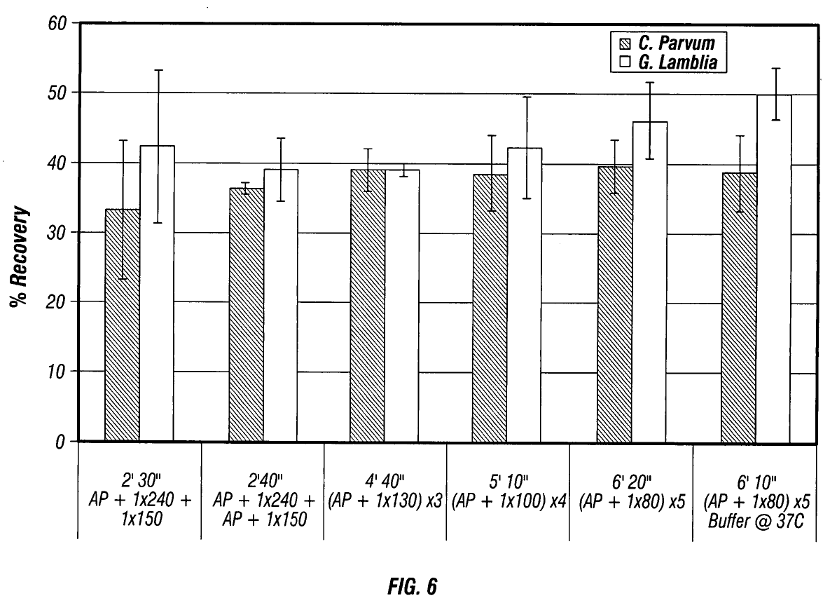

Initially, 10 liters of RO water samples were spiked with 100 Cryptosporidium parvum oocysts and 100 Giardia lamblia cysts (Waterborne™, Inc. New Orleans, La., USA). Water samples containing the spiked Cryptosporidium oocysts and Giardia cysts passed through the filter modules of a 79-Disc filter with the structure described in FIG. 5. The 79-Disc filter module consists of 79 open cell reticulated foam pad rings with two different sizes: 40 of the large foam pads have a 55 mm outer diameter and an 18 mm inner diameter and 39 of the small foam pads have a 40 mm outer diameter and an 18 mm inner diameter. All the foam rings are 10 mm thick. The two sizes of foam pads are sandwiched in an alternating pattern into a stack. The stack is then compressed from about 790 mm to about 30 mm and is tightened by a retaining bolt. This construction resulted in a filter module with two filtration layers: the outer layer of the filter module (i.e., the region radially outward of the outer diameter of the 40 mm foam pads) is compressed 13 fold and acts as a pre-filter and the inner layer of the filter module (i.e., the region radially inward of the outer diameter of the 40 mm foam pads) is compressed 27 fold and acts as a size exclusion filter. The 79-Disc filters were processed to elute the captured organisms using different embodiments of this invention. These included: (1) 2 sequential pressurized buffer elution (1×240 mL+1×150 mL); (2) one time compressed air purge followed by 2 sequential pressurized buffer elution (i.e. AP+1×240 mL+1×150 mL); (3) one time compressed air purge, one time 240 mL pressurized buffer elution, one time air purge, followed by one time 150 mL pressurized buffer elution (i.e. AP+1×240 mL+AP+1×150 mL); (4) one time compressed air purge followed by 3 times 130 mL pressurized buffer elution; (5) one time compressed air purge followed by 4 times 100 mL pressurized buffer elution; (6) one time compressed air purge followed by 5 times 80 mL pressurized buffer elution; and (7) one time compressed air purge followed by 5 times pressurized buffer elution with the buffer pre-warmed to 37° C. All pressure elution steps were carried out in a flow direction reversed to the sampling step at 4 bars pressure. The buffer solution used for this elution procedure contained Sodium pyrophosphate tetra-basic decahydrate (0.2 gram/Liter), EDTA tri-sodium salt (0.3 gram/Liter), Tris-HCl (0.01 M), and Tween-80 (0.1 mL/Liter). The organisms in the eluted filtrates were purified using a standard immunomagnetic separation method (Dynal® Invitrogen Corporation, Carlsbad, Calif., USA), stained with a fluorescent antibody stain, and enumerated using a fluorescent microscope. As seen in FIG. 6, these data indicated that, using the device of this invention, the recovery efficiencies were essentially similar to one another among different embodiments of this invention.

### Example 5

### Procedural Time Difference Between Filta-Max and the Methods of the Present Invention

In the present example, 5 water samples including 1 reagent water sample (representing clean water sample) and 4 raw water samples with different turbidities were used in this experiment. Water samples passed through the filter modules of a 79-Disc filter with the structure described in FIG. 5. The 79-Disc filter module consists of 79 open cell reticulated foam pad rings with two different sizes: 40 of the large foam pads have a 55 mm outer diameter and an 18 mm inner diameter and 39 of the small foam pads have a 40 mm outer diameter and an 18 mm inner diameter. All the foam rings are 10 mm thick. The two sizes of foam pads are sandwiched in an alternating pattern into a stack. The stack is then compressed from about 790 mm to about 30 mm and is tightened by a retaining bolt. This construction resulted in a filter module with two filtration layers: the outer layer of the filter module (i.e., the region radially outward of the outer diameter of the 40 mm foam pads) is compressed 13 fold and acts as a pre-filter and the inner layer of the filter module (i.e., the region radially inward of the outer diameter of the 40 mm foam pads) is compressed 27 fold and acts as a size exclusion filter.

The Filta-Max modules were processed according to the standard Filta-Max procedures as described in the USEPA Method 1623. The 79-Disc filters were processed using the device and method of this invention (i.e. Pressure Elution). Filta-Max's sample processing time ranged from 11 minutes and 25 seconds to twenty six minutes and forty five seconds depending on the nature of water samples. When the device and method of this invention (i.e. pressure elution) was used to perform the sample elution, the time required to process the elution step only took 2 minutes and five seconds irregardless of the nature of the water samples. As seen in the table below, there is therefore significant benefit in the reduction of sample processing time requirement and labor saving using the device and method of this invention.

| | | Procedural | | |
|---|---|---|---|---|
| | | Time | Added Time | Total Time |
| Filta-Max | Reagent Water | 11:25 | 00:00 | 11:25 |
| Elution | Samples | | | |
| | Average of 4 Raw | 11:25 | 15:20 | 26:45 |
| | Water Samples | | | |
| Pressure | Reagent Water | 2:05 | 00:00 | 2:05 |
| Elution | Samples | | | |
| | Average of 4 Raw | 2:05 | 00:00 | 2:05 |
| | Water Samples | | | |

While the invention has been particularly shown and described with reference to the attached sheets of schematics and drawings, it will be understood by those skilled in the art that various modifications, including without limitation of having a fully automatic device and method to process the sample elution, in form and detail may be made therein without departing from the scope and spirit of the invention. Accordingly, modifications such as those suggested above, but not limited thereto, are to be considered within the scope of the invention.

What is claimed is:

1. An apparatus for eluting microorganisms from filter media comprising:
a housing configured and dimensioned to receive filter media, the housing having an inlet and an outlet;
filter media disposed in the housing, the filter media having been exposed to a liquid suspected of containing microorganisms;
means for transporting a liquid buffer solution into the housing via the outlet; and
means for causing the liquid buffer solution to pass through the filter media under pressure and to exit the housing via the inlet.

2. The apparatus according to claim 1, wherein the means for causing the fluid buffer solution to pass through the filter media include a pressurizing assembly selectively connectable to the outlet of the housing.

3. The apparatus according to claim 2, wherein the pressurizing assembly includes a pressure chamber configured for pressurizing a quantity of a liquid buffer solution therein prior to transportation of the liquid buffer solution to the housing.

4. The apparatus according to claim 3, wherein the pressure chamber is in selective fluid communication with a source of pressurizing gas.

5. The apparatus according to claim 4, wherein the pressurizing assembly includes an air valve fluidly disposed between the source of pressurizing gas and the pressure chamber and a non-return valve fluidly disposed between the air valve and the pressure chamber.

6. The apparatus according to claim 2, further comprising a reservoir configured to store a quantity of a liquid buffer solution therein, and a first conduit in fluid communication with the reservoir, wherein the first conduit includes a free end configured to selectively fluidly connect with the pressure chamber.

7. The apparatus according to claim 6, further comprising a liquid buffer solution contained within the reservoir.

8. The apparatus according to claim 7, further comprising a buffer inlet valve fluidly disposed between the reservoir and the pressure chamber.

9. The apparatus according to claim 8, further comprising an elution valve fluidly connected to the pressure chamber and fluidly connectable to the outlet of the housing.

10. The apparatus according to claim 9, further comprising a venting valve fluidly connected to the pressure chamber.

11. The apparatus according to claim 10, wherein the pressure chamber is pressurizable to a pressure of between about 0 psi (0 Bars) to at least about 72.5 psi (5.0 Bars).

12. The apparatus according to claim 1, wherein the filter media includes a plurality of discs stacked upon one another, wherein the stack of discs alternate between relatively large outer diameter discs and relatively small outer diameter discs, and wherein the stack of discs is compressed in a linear direction.

13. A method for eluting microorganisms from filter media comprising the steps of:
providing filter media suspected of containing microorganisms; and
forcing a pressurized liquid through the filter media to at least partially elute microorganisms from the filter media, if present.

14. The method according to claim 13, wherein the step of forcing a pressurized liquid through the filter media includes forcing the pressurized liquid through the filter media in a direction opposite to a direction of filtration.

15. The method according to claim 14, further comprising the step of forcing a fixed quantity of pressurized liquid at a known initial pressure through the filter media.

16. The method according to claim 15, further comprising the step of providing an apparatus for eluting the filter media; the apparatus including:
a pressurizing assembly selectively connectable to the outlet of the housing, wherein the pressurizing assembly includes a pressure chamber configured for pressurizing a quantity of a liquid buffer solution therein prior to transportation of the liquid buffer solution to the housing;
a source of pressurizing gas in selective fluid communication with the pressure chamber;
an air valve fluidly disposed between the source of pressurizing gas and the pressure chamber and a non-return valve fluidly disposed between the air valve and the pressure chamber;
a reservoir configured to store a quantity of a liquid buffer solution therein, and a first conduit in fluid communication with the reservoir, wherein the first conduit includes a free end configured to selectively fluidly connect with the pressure chamber;
a liquid buffer solution contained within the reservoir;
a buffer inlet valve fluidly disposed between the reservoir and the pressure chamber;
an elution valve fluidly connected to the pressure chamber and fluidly connectable to the outlet of the housing; and
a venting valve fluidly connected to the pressure chamber.

17. The method according to claim 16, further comprising the step of:
introducing a fixed quantity of liquid buffer solution to the pressure chamber.

18. The method according to claim 17, further comprising the step of pressurizing the pressure chamber a pressure of between about 0 psi (0 Bars) to at least about 72.5 psi (5.0 Bars).

19. The method according to claim 18, further comprising the step of:
forcing the pressurized liquid buffer solution through the filter media.
